(19) United States
(12) Patent Application Publication
(10) Pub. No.: US 2014/0118121 A1
(43) Pub. Date: May 1, 2014

(54) ELECTRONIC DEVICE FOR CONTROLLING ANOTHER ELECTRONIC DEVICE

(71) Applicant: HON HAI PRECISION INDUSTRY CO., LTD, New Taipei (TW)

(72) Inventors: HO-LEUNG CHEUNG, Santa Clara, CA (US); TZU-CHIAO SUNG, New Taipei (TW)

(21) Appl. No.: 13/909,089

(22) Filed: Jun. 4, 2013

(30) Foreign Application Priority Data
Oct. 25, 2012 (TW) 101139567

(51) Int. Cl. G08C 19/00

(52) U.S. Cl. CPC G08C 19/00
USPC 340/12.22

(57) ABSTRACT

A control method used between a first electronic device and a second electronic device, which has a type of controller different from the first electronic device, is provided. The control method includes receiving user inputs from an input unit of the second electronic device and generating corresponding operating signals. Acquiring the operating signal, converting the operating signals into commands, which can be identified by the first electronic device, sending the command to the first electronic device and executing the command and thus control the first electronic device.

### BACKGROUND

1. Technical Field

The present disclosure relates to electronic devices and, more particularly, to an electronic device able to control another electronic device which has a different type of controller.

2. Description of Related Art

A controller of one electronic device often cannot be used to control another electronic device, which is inconvenient.

Therefore, it is desirable to provide an electronic device able to control another electronic device which has a different type of controller from the electronic device.

### BRIEF DESCRIPTION OF THE DRAWINGS

FIG. 1 is a schematic diagram showing a remote control system comprising a first electronic device and a second electronic device in a first embodiment.

FIG. 2 is an overview diagram showing connection of the first electronic device and the second electronic device in FIG. 1.

FIG. 3 is a flowchart diagram showing the first electronic device to control the second electronic device in a first embodiment.

FIG. 4 is a schematic diagram showing a remote control system comprising a first electronic device and a second electronic device in a second embodiment.

### DETAILED DESCRIPTION

Embodiments of the disclosure will be described with reference to the accompanying drawings.

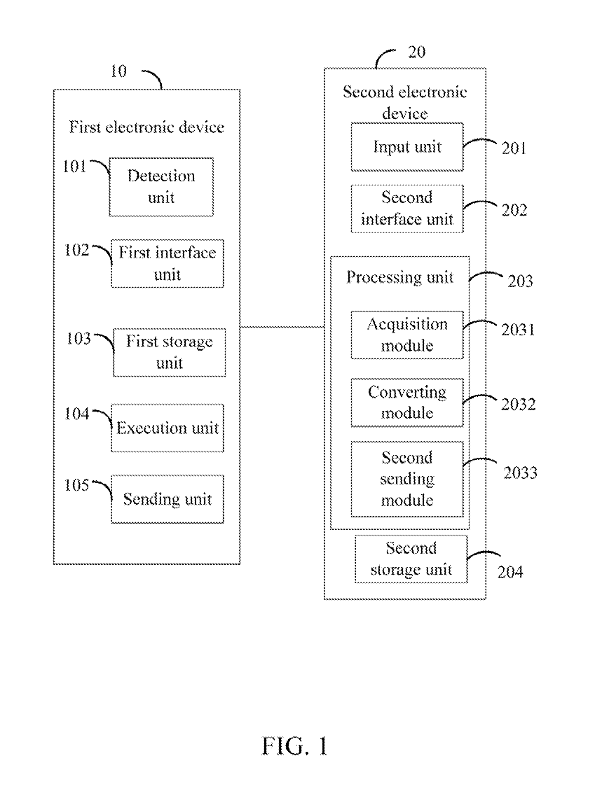

FIG. 1 is a remote control system, according to an embodiment. The remote control system includes a first electronic device 10 and a second electronic device 20. The first electronic device 10 and the second electronic device 20 have different types of controllers. The first electronic device 10 may be a television or a gaming device, and the second electronic device 20 may be a cell phone or a tablet computer. The first electronic device 10 and the second electronic device 20 can communicate with each other via a universal serial bus connection, an infrared connection, or a Wi-Fi connection. The first electronic device 10 serves as a host and the second electronic device 20 serves as a remote controller for the host. That is, the first electronic device 10 can be remotely controlled by operating the second electronic device 20.

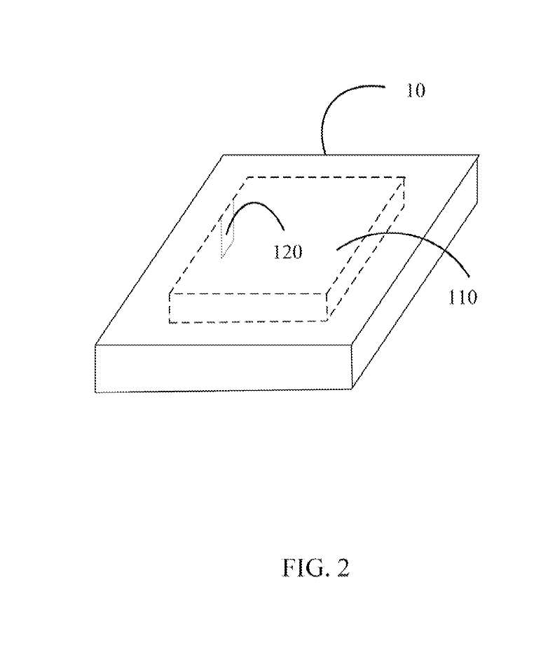

FIG. 2 shows that the first electronic device 10 defines a receiving space 110 and forms an interface 120 exposed to the receiving space 110. The second electronic device 20 can be received in the receiving space 110 and can be connected to the first electronic device 10 via the interface 120. In this embodiment, the interface 120 is a USB connector.

The first electronic device 10 includes a detection unit 101, a first interface unit 102, a first storage unit 103, an execution unit 104, and a sending unit 105. The first interface unit 102 is the interface 120 shown in FIG. 2.

The detection unit 101 is configured to detect whether the second electronic device 20 is connected with the first electronic device 10. If yes, the detection unit 101 generates an activation signal.

The first storage unit 103 pre-stores a plurality of rules to convert operating signals from other electronic devices, such as the second electronic device 20, into commands, which can be identified by the first electronic device 10.

The sending unit 105 is configured to send the activation signal to the second electronic device 20 via the first interface unit 102 to activate the second electronic device 20. Being activated, the second electronic device 20 automatically downloads the application system from the first storage unit 103 and installs the application system. In other embodiments, the application system can be pre-installed in the second electronic device 20.

The execution unit 104 is configured to execute the commands and thus control the first electronic device 10.

The second electronic device 20 includes an input unit 201, a second interface unit 202, a processing unit 203, and a second storage unit 204.

The input unit 201 is configured to receive user inputs and generate corresponding operating signals. The second storage unit 204 also pre-stores the rule to convert operating signals from the second electronic device 20 into commands, which can be identified by the first electronic device 10.

The second interface unit 202 is configured to interface with the first interface unit 102.

The processing unit 203 is configured to execute the application system to form an acquisition module 2031, a converting module 2032, and a second sending module 2033.

The acquisition module 2031 is configured to acquire the operating signal from the input unit 201. The converting module 2032 is configured to convert the operating signals into commands, which can be identified by the first electronic device 10 using the rule in the table which is stored in first storage unit 103 or the second storage unit 204.

The second sending module 2033 is configured to send the command to the first electronic device 10 via the second interface unit 202 and the first interface unit 101.

As such, the second electronic device 20 can be used to control another electronic device (not shown) by editing the table and downloading and installing corresponding application system.

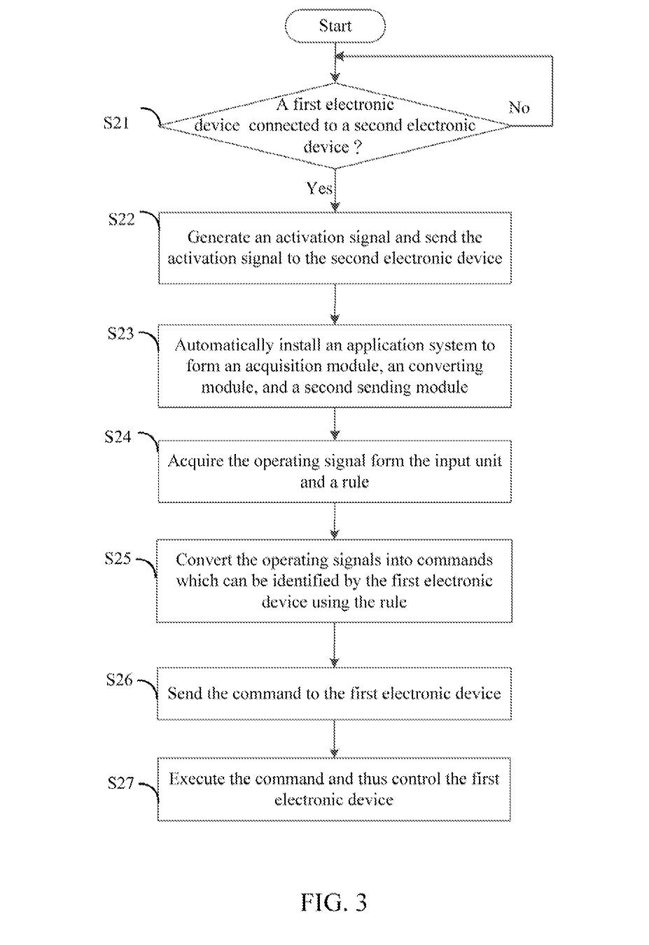

FIG. 3 shows a method for controlling the first electronic device 10 using the second electronic device 20 can be implemented by following steps S21-S27.

In the step S21, the detection unit 101 detects whether the first electronic device 10 is connected to the second electronic device 20. If yes, the step S22 is carried out, if no, the step S21 repeated.

In the step S22, the detection unit 101 generates the activation signal to the second electronic device 20, the sending unit 105 sends the activation signal to the second electronic device 20 via the first interface unit 102 to activate the second electronic device 20.

In the step S23, the second electronic device 20 automatically installs the application system from the first storage unit 103 to form the acquisition module 2031, the converting module 2032 and the second sending module 2033. In other embodiments, the application system can be preinstalled and thus this step can be omitted.

In the step S24, the acquisition module 2031 acquires the operational signal from the input unit 201, also acquires the rule from the first electronic device 10 via the second interface unit 202 and the first interface unit 101 or from the second storage unit 204.

In the step S25, the converting module 2032 converts the operating signals into commands which can be identified by the first electronic device 10 using the rule in the table which is stored in first storage unit 103 or the second storage unit 204.

In the step S26, the second sending module 2033 sends the command to the first electronic device 10 via the second interface unit 202 and the first interface unit 101.

In the step S27, the execution unit 104 executes the command and thus controls the first electronic device 10.

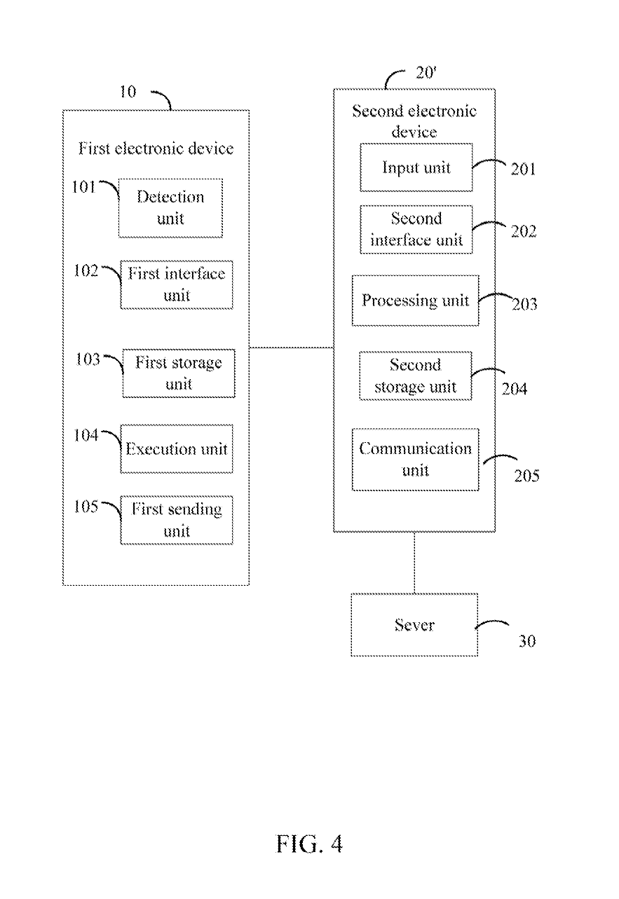

FIG. 4 show that compared with FIG. 1, the second electronic device 20′ further includes a communication unit 205, for supplying network connection function to connect the second electronic device 20′ to a server 30.

The server 30 stores a data base including user accounts. After a user input account information via the input unit 201 of the second electronic device 20′, the communication unit 205 sends the input account information to the server 30 to verify, and receives a result of verifying from the server 30. If the result is input account information is verified, the second electronic device 20′ controls the processing unit 203 to work.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An electronic device to control another electronic device which has a type of controller different from the electronic device and has a first interface unit, the electronic device comprising:
an input unit, to receive user inputs and generate corresponding operating signals;
a second interface unit, to interface with the first interface unit of the another electronic device; and
a processing unit comprising :
an acquisition module, to acquire the operating signals from the input unit,
a converting module, to convert the operating signals into commands which can be identified by the first electronic device, and
a sending module, to send the command to the another electronic device via the second interface unit and the first interface unit, wherein the command is used to control the another electronic device.

2. The electronic device according to claim 1, further comprising a storage unit pre-stores a rule to convert operating signals from the another electronic device into commands which can be identified by the electronic device, wherein the acquisition module acquires the operating signal from the input unit and the rule from the storage unit and the converting module converts the operating signals into commands which can be identified by the first electronic device using the rule.

3. The electronic device according to claim 2, wherein the storage unit pre-stores an application system, after the electronic device is activated by an activating signal sent by the another electronic device, the electronic device automatically downloads the application system from the storage unit and installs the application system to form the acquisition module, the converting module and the second sending module.

4. The electronic device according to claim 1, wherein the another electronic device further comprises an another storage unit pre-stores a rule to convert operating signals from the another electronic device into commands which can be identified by the electronic device, the acquisition module acquires the operating signal from the input unit and the rule from the another storage unit, the converting module converts the operating signals into commands which can be identified by the first electronic device using the rule.

5. The electronic device according to claim 4, wherein the another storage unit further pre-stores an application system, after the electronic device is activated by an activating signal sent by the another electronic device, the electronic device automatically downloads the application system from the another storage unit and installs the application system to form the acquisition module, the converting module and the second sending module.

6. The electronic device according to claim 1, further comprising a communication unit for supplying network connection function to connect the electronic device to a server, wherein the server stores a data base including user accounts, after a user input account information via the input unit of the electronic device, the communication unit sends the input account information to the server to verify, and receives a result of verifying from the server, controls the processing unit to work when the result is input account information is verified.

7. An electronic device to be controlled by another electronic device which has a type of controller different from the electronic device, the electronic device comprising:
a storage unit, to pre-store a rule to convert operating signals form the another electronic device into commands which can be identified by the electronic device and an application system;
a detection unit, to detect if the another electronic device is connected with the electronic device and generate an activation signal when the another electronic device is connected with the electronic device; and
a sending unit, to send the activation signal to the another electronic device to activate the another electronic device,
wherein after the another electronic device is activated, the another electronic device automatically downloads an application system from the storage unit and installs the application system to form an acquisition module, a converting module, and a second sending module,
wherein the acquisition module acquires operating signal from an input unit of the another electronic device, the converting module converts the operating signals into commands which can be identified by the electronic device, and the sending module sends the command to the electronic device.

8. The electronic device according to claim 7, further comprising an execution unit to execute the command and thus control the electronic device.

9. The electronic device according to claim 7, further comprising a receiving space and an interface exposed to the receiving space, wherein the another electronic device is received in the receiving space and connected to the electronic device via the interface.

10. A control method used between a first electronic device and a second electronic device which has a type of controller different from the first electronic device, the control method comprising:
receiving user inputs from an input unit of the second electronic device and generate corresponding operating signals;
acquiring the operating signal;
converting the operating signals into commands which can be identified by the first electronic device;
sending the command to the first electronic device; and
executing the command and thus control the first electronic device.

11. The control method according to claim 10, wherein the first electronic device comprises a first storage unit pre-stores a rule to convert operating signals form the second electronic device into commands which can be identified by the first electronic device, the method further comprises acquiring the rule from the first storage unit and converting the operating signals into commands which can be identified by the first electronic device using the rule.

12. The control method according to claim 11, wherein the first storage unit pre-stores an application system, the method further comprises activating the second electronic device after receiving an activating signal sent by the first electronic device, automatically downloads the application system from the first storage unit and installs the application system to perform the steps of acquiring the operating signal, acquiring the rule from the first storage unit, converting the operating signals into commands which can be identified by the first electronic device using the rule, and sending the command to the first electronic device.

13. The control method according to claim 10, wherein the second electronic device further comprises a second storage unit pre-stores a rule to convert operating signals form the second electronic device into commands which can be identified by the first electronic device, the method further comprises acquiring the rule from the second storage unit and converting the operating signals into commands which can be identified by the first electronic device using the rule.

14. The control method according to claim 13, wherein the second storage unit further pre-stores an application system, after the second electronic device is activated by an activating signal sent by the another electronic device, the method further comprises activating the second electronic device after receiving an activating signal sent by the first electronic device, automatically downloads the application system from the second storage unit and installs the application system to perform the steps of acquiring the operating signal, acquiring the rule from the second storage unit, converting the operating signals into commands which can be identified by the first electronic device using the rule, and sending the command to the first electronic device.

15. The control method according to claim 10, wherein the second electronic device further comprises a communication unit for supplying network connection function to connect the second electronic device to a server, the control method further comprises sending input account information from the input unit of the second electronic device to the server to verify, receiving a result of verifying from the server, and activating the second electronic device after receiving an activating signal sent by the first electronic device and the result is input account information is verified.
